(19) United States
(12) Patent Application Publication
(10) Pub. No.: US 2005/0022048 A1
(43) Pub. Date: Jan. 27, 2005

(54) Fault tolerance in networks

(75) Inventor: Simon Edwin Crouch, Bristol (GB)

Correspondence Address: HEWLETT-PACKARD COMPANY;Intellectual Property Administration, P.O. Box 272400, Fort Collins, CO, 80527-2400, US

(73) Assignee: Hewlett-Packard Development Co., L.P.

(21) Appl. No.: 10/850,160

(22) Filed: May 19, 2004

(30) Foreign Application Priority Data
Jun. 25, 2003 (GB) 0314792.3

(51) Int. Cl. G06F 11/00

(52) U.S. Cl. 714/4

(57) ABSTRACT

A method of providing a fault tolerant network, the network comprising a plurality of interconnected network nodes, the method comprising: determining an automorphism of the network; and periodically storing the current state of each network node at the corresponding network node of the automorphic image whilst each network node is substantially fault free.

### BACKGROUND OF THE INVENTION

As is well known in the art, the majority of computer networks comprise a number of individual network nodes inter-connected to one another via a number of network connections. Perhaps the most familiar example is a computer network in which each network node comprises a personal computer, or workstation, with the network connections comprising physical wired interconnections. Of course for larger networks the network connections may be wireless (radio) connections or may make use of existing telecommunications infrastructure. Conversely, a number of separate microprocessors within a ‘supercomputer’ can equally be considered a computer network.

It is desirable that the network is as fault tolerant as possible. Fault tolerance is a term used to describe, in this context, the ability of a network to continue to function in a manner acceptable to the network users despite the occurrence of one or more faults or failures within the network itself. For example should one of the network nodes or network connections fail, it is desirable that the remainder of the network is able to continue to function correctly.

Additionally, although less importantly, it is also desirable that in the event of a part of the network suffering a failure, information concerning the failed network elements is available to the functioning remainder of the network. This is primarily for diagnostic and fault reporting purposes.

Such fault tolerance is relatively easy to achieve for a network arranged to operate using a server-client protocol. In such a network there are a relatively small number of network nodes that are arranged to operate as network servers. Each network server is assigned responsibility for running and managing one or more aspects of the network operation. Consequently, if a network node other than a server or a network connection suffers a failure the operation of the server is not impaired and the server can continue to run and manage the remainder of the network, making whatever adjustments or allowances it deems necessary. Even should a server fail, the remaining servers are often capable of assuming the operation of the network tasks assigned to it. Alternatively or additionally, because the number of servers is small in comparison to the network itself and the operation of the servers is well defined, it is feasible to have in place duplicate back-up servers solely to take-over the tasks of a failed server.

The server-client network configuration also makes the provision of diagnostic and error logging facilities relatively straightforward as these can be performed as part of the running of the network done by the servers.

However, not all networks operate using server-client protocols, making the application of fault tolerance measures difficult. An example of such a network is a peer-to-peer network, in which there are no hierarchical controllers or central resources allocated to perform centralised functions, such as diagnostics. Each element, or network node, of a peer-to-peer network must cooperate with one another to perform these functions. Whilst this results in a flexible network arrangement, it can result in some critical functions of the network being concentrated on a small number of network nodes. Consequently, failure of one of those nodes can have a significant input on the networks performance. That failure may be caused by overloading a node.

Furthermore, peer-to-peer networks are particularly suited to the constant addition and removal of network nodes. Consider a peer-to-peer network comprised of a number of mobile computers, each having wireless communication facilities. As new, similarly equipped, computers come within range of one or more of the existing networked computers they can join the network. Consequently, the actual configuration, or topology, formed by the various nodes and connections in a peer-to-peer network may be variable. This makes it more difficult to ensure fault tolerance or provide diagnostic facilities.

### SUMMARY OF THE INVENTION

According to the present invention there is provided a method of providing a fault tolerant network, the network comprising a plurality of interconnected nodes, the method comprising determining an automorphism of the network and periodically storing the current state of each network node at the corresponding network node of the automorphic image whilst each network node is substantially fault free.

Thus, in the event of the failure of one or more nodes within the network it should be possible to retrieve the state of the failed nodes immediately prior to failure from their corresponding nodes of the automorphic image to allow for their correction or diagnosis.

In mathematical terms, a “graph” G (sometimes called a “network”) is a mathematical object composed of points known as “vertices” or “nodes” together with lines connecting some (possibly empty) subset of them, known as “edges”. The “degree” of any given vertex is the number of edges incident upon that vertex. An “isomorphism” between two graphs is a one-to-one mapping between their two sets of vertices. An “automorphism” of a graph is a graph isomorphism with itself, i.e., a mapping from the vertices of the given graph G back to vertices of G such that the resulting graph is isomorphic with G.

Additionally, the step of determining the automorphism may comprise: determining a set of automorphisms of the network; for each automorphism within the set determining a first ranking value according to one or more predetermined criteria; and selecting the automorphisms having the optimum first ranking value.

The step of determining the first ranking value may comprise determining for each network node the distance between a said node and its corresponding node in the automorphic image of the network and summing said distances.

Alternatively, the step of determining the first ranking value may comprise determining for each network node the distance between said node and its corresponding node in the automorphic image of the network and determining the average value of the distance.

Alternatively, the step of determining the first ranking value may comprise determining for each network node the distance between said node and its corresponding node in the automorphic image of the network and determining the minimum value of said distance.

Alternatively, the step of determining the first ranking value may comprise determining for each network node the distance between said node and its corresponding node in the automorphic image of the network and determining the proportion of network nodes for which said distance is greater than a threshold value.

The automorphism having the maximum first ranking value may be selected.

Additionally, the method may further comprise, in response to a change of the number of the network nodes comprising the network, re-determining an automorphism for the network and transmitting the stored current state of each network node from the network node that which it was previously stored to the corresponding node of the automorphic image of the network under the re-determined automorphism.

Additionally, the step of re-determining the automorphism may comprise determining a set of automorphisms of the changed network, for each automorphism within the set determining a second ranking value according to one or more predetermined criteria and selecting the autormorphism having the optimum second ranking value.

The step of determining the second ranking value may comprise any one of the previously described methods. Alternatively or additionally, the step of determining the second ranking value may comprise determining the number of nodes in the automorphic image of the re-determined automorphism that do not directly correspond to respective node in the automorphic image of the previously determined automorphism.

According to the present invention there is provided a fault tolerant network comprising a plurality of interconnected nodes, wherein the at least one of said nodes is arranged to determine an automorphism of the network and each node is arranged, in response to the determination of the automorphism, to periodically transmit data representative of its current state to the network node corresponding to the respective node in the image of the network under the automorphism whilst each network node is substantially fault free.

Preferably, the at least one node is arranged to determine the automorphism according to any one of the methods referred to above.

Additionally or alternatively, in response to the network being expanded by the addition of at least one further node, the at least one further node may be arranged to determine a further automorphism of the expanded network and each node of the expanded network is arranged to transmit data representative of its current state to the node of the expanded network corresponding to the respective node in the image of the expanded network under the further automorphism.

According to the present invention there is provided a data processor arranged to be networked with a plurality of other data processors in a network, wherein said data processor is further arranged to determine an automorphism of the network and to periodically transmit data representative of its current state to the network node corresponding to the respective node in the image of the network under the automorphism whilst the node is substantially fault free.

Preferably, the data processor is arranged to determine the automorphism according to any one of the methods referred to above.

### DESCRIPTION OF THE DRAWINGS

An embodiment of the present invention will now be described, as an illustrative example only, with reference to the accompanying figures, of which:

FIG. 1 illustrates a network and its automorphic image; and

FIG. 2 illustrates the network shown in FIG. 1 to which an additional node has been added.

### DETAILED DESCRIPTION OF THE INVENTION

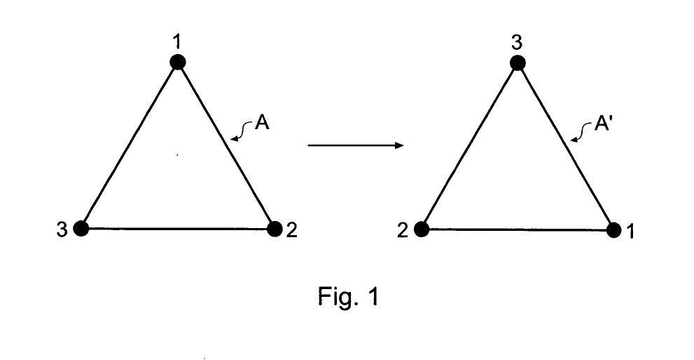

A network of data processors, such as a network according to embodiments of the present invention, can be represented as a mathematical object composed of a number of nodes, together with interconnections connecting a, possibly empty, subset of the nodes, the interconnections known as “edges”. The “degree” of any given node is the number of edges incident upon that node. For example, the network A illustrated in FIG. 1 is composed of three nodes 1, 2, 3 each interconnected to one another with two edges.

An automorphism is a mapping function that when applied to a network generates a new network that is topologically identical to the original network. The network produced by applying the automorphism is referred to as the automorphic image. Referring to FIG. 1, the automorphism applied to original network A comprises effectively rotating the network by 120°. Hence node 1 is mapped onto node 2, node 2 is mapped onto node 3 and so on. The automorphic image is shown in FIG. 1 and is labelled A′. As can be seen, the resulting mapped network A′ is topologically identical to the original network, i.e. network A′ is an automorphic image of the network A.

In general, a network G consists of a number of nodes n1, n2, . . . , each node being connected to one or more others. It is possible to define the “distance” d (n1, n2) between two nodes n1 and n2 as being the minimum number of interconnections it is necessary to traverse to travel from node n1 to node n2. If F is an automorphism of G, it is possible to define several measures of “distance”, D, between network G and the automorphic image of network G under automorphism F, F(G). For example:
i) D1 (G, F(G)) is the sum of d(n1, F)(n1)) over all the nodes of network G.
ii) D2 (G, F(G)) is the minimum value of d(n1, F)(n1)) over the nodes of network G.
iii) D3 (G, F(G)) is the average value of d(n1, F)(n1)) over the nodes of network G.
iv) D4 (G, F(G)) is the proportion of the nodes of network G for which d(n, F)(n)) is greater than a fixed constant C.

If a single node is added to the existing network G to produce a new network G′, then there will be a new automorphism F′ of the network G′. It is thus possible to define the “distance” d(F, F′) between the automorphisms F and F′ to be the number of nodes Y in the network G for which F(Y) is not equal to F′(Y). If d(F, F′) is small, then the automorphism F′ is said to be “not very much different” from automorphism F.

The general mathematical problem of finding whether two graphs are isomorphic and finding the isomorphism between them is computationally hard. However, the problem under consideration here is a much easier one—finding all the automorphisms of a given graph (especially if it is assumed that the maximum vertex degree of the graph is bounded by a constant, which in the example of computer networks is always the case). Such algorithms are widely implemented, for example in the well known mathematical software package “Mathematica” (provided by Wolfram Research, Inc.)—see for example Skiena, S. “Graph Isomorphism.” §5.2 in Implementing Discrete Mathematics: Combinatorics and Graph Theory with Mathematica. Reading, Mass.: Addison-Wesley, pp. 181-187, 1990.

In embodiments of the present invention, the concept of automorphisms is applied to a network of data processors so as to provide a fault tolerant network. In embodiments of the present invention one of the nodes of a network, for example node 1 in the network A illustrated in FIG. 1, is arranged to calculate the set of possible automorphisms of the network and to calculate which of these automorphisms optimises one of the distance measures described above. It will be appreciated that, in accordance with the explanation of an automorphism given previously, each of the automorphisms will be derived from the entire network. That is, the automorphic images will have the same number of nodes as there are network nodes in the existing network. Each network element is arranged to subsequently store a copy of its current state on the node or interconnection that is its automorphic image under the chosen automorphism. The storage of the state of the network nodes occurs when the network is functioning normally, i.e. when there are no faulty nodes in existence, and occurs repeatedly on a periodic basis. Hence a substantially up-to-date state of the network is always stored in such a manner that should a particular node fail, then the state of that node prior to failure is available to the remainder of the network. The state of a node prior to its failure, together with the state of the remaining nodes, can be used to reconfigure the remaining nodes to perform the same tasks as the original network. Alternatively the status of a node prior to its failure can be used in fault diagnosis.

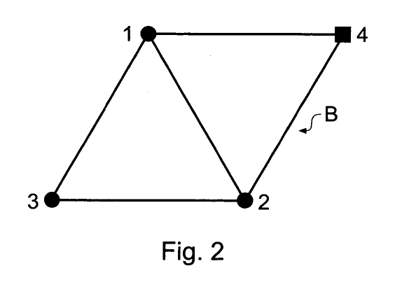

FIG. 2 illustrates the original network shown in FIG. 1 but with the addition of an extra node. According to embodiments of the present invention, whenever a new node joins the network, it is responsible for calculating the new set of automorphisms for the newly formed network. It selects the new automorphism and propagates this new automorphism through the network. The network elements then transfer their state information to the new nodes and interconnections that are their images under the new chosen automorphism. As for the embodiment described above, the process of storing the state information for the network nodes is then repeated periodically to maintain the current or relatively recent status of each node. For the network shown in FIG. 2, the possible automorphisms are:
A=(1, 2, 3, 4)−the identity
B=(1,3,2,4)
C=(4,2,3,1)
D=(4,3,2,1)

If the original network was G and its associated automorphism was F and the new network, represented in FIG. 2 by network B, is G′, then the new automorphism F′ may be chosen in a number of ways. For example, the automorphism F′ may be chosen to maximise the “distance” d (G′, F′(G′)). This provides the optimum new solution in terms of the “distance” between the new network G′ and its image under the new automorphism F′. However, the solution may involve a considerable change between the original automorphism F and the new automorphism F′ and thus may involve considerable transfer of data around the network in response to the joining of a new element. Alternatively, the new automorphism F′ may be chosen to minimise the “distance” d(F, F′). We define the “distance” d(F, F′) between the automorphisms F and F′ to be the number of nodes in the original network G for which F(Y) is not equal to F′(Y). That is to say, the number of nodes in the new automorphism F′ that do not exactly correspond to a node in the previously determined automorphism F. This may provide a good, but sub-optimal, solution with regard to fault tolerance, but reduces the perturbation of F and will thus result in less data being transferred around the network whenever a new node joins. A further alternative may be a combination of the above two selection mechanisms. The new automorphism, F′ may be chose to minimise d(F, F′) unless D(G′, F′, G′) is below a minimum value. Alternatively, the distance in d(F, F′) may be used to select F′ for a fixed number of times when new nodes join a network but the maximisation of D(G′, F′) G′) may be used for any node that joins after that fixed number has been exceeded.

1. A method of providing a fault tolerant network, the network comprising a plurality of interconnected network nodes, the method comprising:
determining an automorphism of the network; and
periodically storing the current state of each network node at the corresponding network node of the automorphic image whilst each network node is substantially fault free.

2. A method according to claim 1, wherein the automorphic image comprises each node of the network.

3. A method according to claim 1, wherein the step of determining the automorphism comprises:
determining a set of automorphisms of the network;
for each automorphism within the set, determining a first ranking value according to one or more predetermined criteria; and
selecting the automorphism having the optimum first ranking value.

4. A method according to claim 3, wherein the step of determining the first ranking value comprises determining for each network node the distance between said node and its corresponding node in the automorphic image of the network and summing said distances.

5. A method according to claim 3, wherein the step of determining the first ranking value comprises determining for each network node the distance between said node and its corresponding node in the automorphic image of the network and determining the average value of said distance.

6. A method according to claim 3, wherein the step of determining the first ranking value comprises determining for each network node the distance between said node and its corresponding node in the automorphic image of the network and determining the minimum value of said distance.

7. A method according to claim 3, wherein the step of determining the first ranking value comprises determining for each network node the distance between said node and its corresponding node in the automorphic image of the network proportion of the network nodes for which said distance is greater than a threshold value.

8. A method according to claim 1, wherein the method further comprises, in response to a change in the number of network nodes comprising said network:
re-determining an automorphism for the network; and
transmitting the stored current state of each network node.

9. A method according to claim 8, wherein the step of re-determining the automorphism comprises:
determining a set of automorphisms of the changed network;
for each automorphism within the set, determining a second ranking value according to one or more predetermined criteria; and
selecting the automorphism having the optimum second ranking value.

10. A method according to claim 9, wherein the step of determining the second ranking value comprises determining for each network node the distance between said node and its corresponding node in the automorphic image of the network and summing said distances.

11. A method according to claim 9, wherein the step of determining the second ranking value comprises determining for each network node the distance between said node and its corresponding node in the automorphic image of the network and determining the average value of said distance.

12. A method according to claim 9, wherein the step of determining the second ranking value comprises determining for each network node the distance between said node and its corresponding node in the automorphic image of the network and determining the minimum value of said distance.

13. A method according to claim 9, wherein the step of determining the second ranking value comprises determining for each network node the distance between said node and its corresponding node in the automorphic image of the network proportion of the network nodes for which said distance is greater than a threshold value.

14. A method according to claim 9, wherein the step of determining the second ranking value comprises determining the number of nodes in the automorphic image of the redetermined automorphism that do not directly correspond to a respective node in the automorphic image of the previously determined automorphism.

15. A fault tolerant network comprising a plurality of interconnected network nodes, wherein at least one of said network nodes is arranged to determine an automorphism of the network and each network node is arranged, in response to the determination of the automorphism, to periodically transmit data representative of its current state to the network node corresponding to the respective node in the image of the network under the automorphism whilst each network node is substantially fault free.

16. A fault tolerant network according to claim 15, wherein in response to the network being expanded by the addition of at least one further node, said at least one further node is arranged to determine a further automorphism of the expanded network and each node of the expanded network is arranged to periodically transmit data representative of its current state to the node of the expanded network corresponding to the respective node in the image of the expanded network under the further automorphism whilst each respective network node is substantially fault free.

17. A fault tolerant network according to claim 16, wherein the at least one further node is arranged to:
determine a set of automorphisms of the expanded network;
for each automorphism within the set, determine a ranking value according to at least one predetermined criteria; and
select the automorphism having the optimum ranking value.

18. A fault tolerant network according to claim 17, wherein the least one further node is arranged to determine the ranking value by determining for each network node the distance between said node and its corresponding node in the automorphic image of the network and summing said distances.

19. A fault tolerant network according to claim 17, wherein the least one further node is arranged to determine the ranking value by determining for each network node the distance between said node and its corresponding node in the automorphic image of the network and determining the average value of said distance.

20. A fault tolerant network according to claim 17, wherein the least one further node is arranged to determine the ranking value by determining for each network node the distance between said node and its corresponding node in the automorphic image of the network and determining the minimum value of said distance.

21. A fault tolerant network according to claim 17, wherein the least one further node is arranged to determine the ranking value by determining for each network node the distance between said node and its corresponding node in the automorphic image of the network proportion of the network nodes for which said distance is greater than a threshold value.

22. A data processor arranged to be networked with a plurality of other data processors in a network, wherein said data processor is further arranged to determine an automorphism of the network and to periodically transmit data representative of its current state to the network node corresponding to the respective node in the image of the network under the automorphism whilst the node is substantially fault free.

23. A method of providing a fault tolerant network, the network comprising a plurality of interconnected network nodes, the method comprising:
determining a set of automorphisms of the network; for each automorphism within the set, determining a first ranking value according to one or more predetermined criteria;
selecting the automorphism having the optimum first ranking value; and
periodically storing the current state of each network node at the corresponding network node of the automorphic image whilst each network node is substantially fault free.

24. A method of operating a fault tolerant multiprocessor network, each processor being connected to one another, the method comprising:
determining at least one automorphism of the multiprocessor network such that each processor can be mapped to a corresponding processor within the at least one automorphism;
periodically transmitting the current state of each processor to the corresponding processor within the at least one automorphism and storing the current state at that corresponding processor.
